(19) United States
(12) Patent Application Publication
(10) Pub. No.: US 2011/0122165 A1
(43) Pub. Date: May 26, 2011

(54) LAMP DRIVING CIRCUIT HAVING LOW VOLTAGE CONTROL, BACKLIGHT UNIT, AND LIQUID CRYSTAL DISPLAY USING THE SAME

(76) Inventor: Osamu Sengoku, Yokohama (JP)

(21) Appl. No.: 12/817,993

(22) Filed: Jun. 17, 2010

(30) Foreign Application Priority Data
Nov. 24, 2009 (KR) 10-2009-0114174

(51) Int. Cl. G09G 5/10; H05B 41/36

(52) U.S. Cl. 345/690; 315/276; 315/255; 345/102

(57) ABSTRACT

A lamp driving circuit is provided for controlling individual block luminances provided by corresponding locally dimmed blocks of a backlight unit of an LCD system where the backlight unit employs high voltage discharge lamps that each need to have an AC excitation signal of at least predetermined minimum high voltage level developed there across in order to generate light. The lamp driving circuit includes a plurality of isolation transformers and corresponding low voltage switch circuits. Each isolation transformer has primary windings and a secondary winding. The secondary winding is interposed between a high voltage AC power source and a corresponding one or more lamps. The equivalent circuit impedance of the secondary winding determines what voltage will develop across its respective lamps. The low voltage switch circuits are operative to alter the equivalent circuit impedances of their respective primary windings, which impedance changes are then reflected by mutual inductance coupling into the secondary windings. Thus control circuits operating at relatively low voltages can be used to control the ON/OFF states of the lamps.

### CROSS-REFERENCE TO RELATED APPLICATION

This application relies for priority upon Korean Patent Application No. 2009-114174 filed on Nov. 24, 2009, the contents of which are herein incorporated by reference in their entirety.

### BACKGROUND

1. Field of Disclosure

The present disclosure of disclosure relates generally to light-emitting discharge tubes such as cold cathode fluorescent lamps used for light sources of liquid crystal displays, and more specifically to a lamp driving circuit used to selectively turn on and off the discharge tubes, and to a backlight unit having the lamp driving circuit, and to a liquid crystal display (LCD) using the same.

2. Description of Related Technology

Conventionally, cold cathode fluorescent lamps (CCFLs) are used as backlighting light source for liquid crystal displays (LCDs), and inverter circuits are used within the LCD electronics to generate high voltage AC power for turning-on the CCFLs. Recently, a scanning control scheme has been proposed for inverter circuits so as to reduce power consumption of the backlight unit. According to the proposed scanning control scheme, a plurality of CCFLs are grouped into block units, and the on/off operation of each CCFL block is controlled through a time division scheme so that light which is not needed is not wastefully generated.

The backlight unit employing the scanning control scheme includes CCFL blocks and a plurality of inverter circuits connected with the CCFL blocks. The high voltage lamps driving circuits are driven through a time division scheme according to control signals provided from an external control circuit to control the timing of turning on and off of lamps in the CCFL block.

However, since the backlight unit employing the conventional scanning scheme requires as many individually controlled inverter circuits as there are in number the individually controllable lamps of the CCFL blocks, the manufacturing cost of the LCD is increased, and a mounting area for The high voltage lamps driving circuits is increased in proportion to the number and complexity of The high voltage lamps driving circuits used. In addition, the backlight unit employing the scanning control scheme requires additional circuits for the synchronization of operating frequencies of the high voltage lamps driving circuits and the phase synchronization of the CCFL blocks. Accordingly, a method of driving the backlight unit in this way becomes complicated and expensive and more prone to break down as complexity of the control circuits increases.

### SUMMARY

Embodiments in accordance with the disclosure provide a lamp driving circuit capable of simplifying a configuration of a switching circuit. Embodiments in accordance with the disclosure provide an LCD using a backlight unit with the simplified controllable inverter circuit to reduce size, power consumption and price of the backlight unit.

According to embodiments, a lamp driving circuit includes a high frequency isolation transformer and a low voltage switch circuit. A secondary winding of the isolation transformer is connected in series between a high voltage, high frequency power source and a load composed of one or more high voltage discharge tubes. Depending on the AC impedance provided by the secondary winding, a lamps igniting high frequency, high voltage AC signal will be applied or not applied to the discharge tubes and the lamps will light up or not light up accordingly. The switch circuit switches a state of a primary winding of the isolation transformer between first and second different impedance states, for example between an open circuit state and a short circuited state. The switch circuit responds to a low voltage control signal supplied from a controller that determines when and at what duty cycle the lamps will be driven. Since the switch circuit operates at low voltages, it can be made of relatively small and inexpensive circuit components.

According to embodiments disclosed herein, a backlight unit includes a power source, a plurality of discharge tube blocks, a plurality of switch circuits, and a control circuit. Each discharge tube block has a plurality of discharge tubes. The isolation transformers are installed in correspondence with the discharge tube blocks, respectively. Secondary windings of the isolation transformers are connected in series between the high voltage power source and input terminals of the discharge tube blocks. The isolation transformers supply high AC voltage to the discharge tube blocks when the tubes are to be lit. The switch circuits are connected to primary windings of the isolation transformers, respectively, to switch a state of the primary windings for example between an open circuit state and a shorted circuit state according to a control signal. The control circuit generates the control signal to control a switching operation of the switch circuits.

According to embodiments, a liquid crystal display includes a liquid crystal display panel and a backlight. The liquid crystal display panel includes a plurality of liquid crystal devices divided into a plurality of display regions to display an input image. The backlight is provided at a rear of the liquid crystal display panel. The backlight includes a power source, a plurality of discharge tube blocks, a plurality of isolation transformers, a plurality of switch circuits, and a control circuit. The discharge tube blocks include a plurality of discharge tubes and correspond to the display regions. The isolation transformers are installed corresponding to the discharge tube blocks, respectively. Secondary windings of the isolation transformers are connected in series between the power source and input terminals of the discharge tube blocks. The isolation transformers selectively supply high frequency AC voltage signals to the discharge tube blocks. The switch circuits are connected to primary windings of the isolation transformers, respectively, to switch a state of the primary windings to an open state or a short state according a control signal. The control circuit generates the control signal to control a switching operation of the switch circuits.

As described above, the configuration of a circuit used to switch a plurality of CCFL blocks at a high speed is simplified to provide a lighting system driving circuit having small size, low power consumption, and low price and The high voltage lamps driving circuit is employed in the backlight unit and the LCD having a scanning control function for the CCFL blocks or a time control function for turn-on/turn-off operation of each CCFL block such that the size, power consumption and price of the backlight unit and the LCD can be reduced.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a circuit diagram schematically showing a backlight unit according to an embodiment of the present disclosure;

FIG. 2A is a circuit diagram showing an equivalent circuit and its resonant frequency as it appears on the secondary winding side of the isolation transformer of FIG. 1 when the primary winding of the isolation transformer is in the open circuit state;

FIG. 2B is a circuit diagram showing an equivalent circuit and its resonant frequency as it appears on the secondary winding side of the isolation transformer when the primary winding is shorted by an electronically controlled and low voltage switching circuit;

FIG. 2C is a graph showing the variation in resonant frequency and inductance the secondary winding side equivalent circuit when the primary winding is switched from the opened state to the shorted state;

FIG. 3A is a timing and waveforms view showing voltage waveforms at nodes N_{A} and N_{B} of FIG. 1 when the primary side switch is turned off (open circuit state);

FIG. 3B is a timing and waveforms view showing voltage waveforms at the nodes N_{A} and N_{B} of FIG. 1 when the switch is turned on (closed circuit state);

FIG. 4 is a table showing the relation between the variation in impedance values of the primary and secondary windings and the operating state of a CCFL block when the switch of FIG. 1 is turned on or off;

FIG. 5 is a circuit diagram showing a backlight unit using series resonance occurring by an LC series resonant circuit in detail;

FIG. 6A is a view showing the relation between variation in inductance values of the primary and secondary windings of the isolation transformer and the operating state of the CCFL block when FETs of FIG. 5 are turned on or off;

FIG. 6B is a view showing variation in voltage and current when a backlight section of FIG. 5 is turned on/off;

FIG. 7 is a circuit diagram showing a structure in which a TRIAC is connected as the switch of the backlight unit shown in FIG. 1;

FIG. 8 is a circuit diagram showing a structure in which a photo-responsive TRIAC is connected as the switch of the backlight unit shown in FIG. 1;

FIG. 9 is a circuit diagram showing a structure in which MOSFETs are connected as the switch of the backlight unit shown in FIG. 1;

FIG. 10 is a circuit diagram showing a backlight unit according to another embodiment of the present disclosure in detail;

FIG. 11 is a circuit diagram showing a backlight unit according to another embodiment of the present disclosure in detail;

FIG. 12 is a circuit diagram showing a backlight unit according to another embodiment of the present disclosure in detail;

FIG. 13 is a circuit diagram showing a backlight unit according to another embodiment of the present disclosure in detail;

FIG. 14 is a circuit diagram showing a backlight unit according to another embodiment of to the present disclosure in detail;

FIG. 15 is a circuit diagram showing a backlight unit according to another embodiment of the present disclosure in detail;

FIG. 16 is a block diagram showing an LCD according to another embodiment of the present disclosure; and

FIG. 17 is an exploded perspective view showing the structure of the LCD shown in FIG. 16.

### DETAILED DESCRIPTION

Hereinafter, embodiments in accordance with the present disclosure of disclosure will be described in more detail with reference to accompanying drawings.

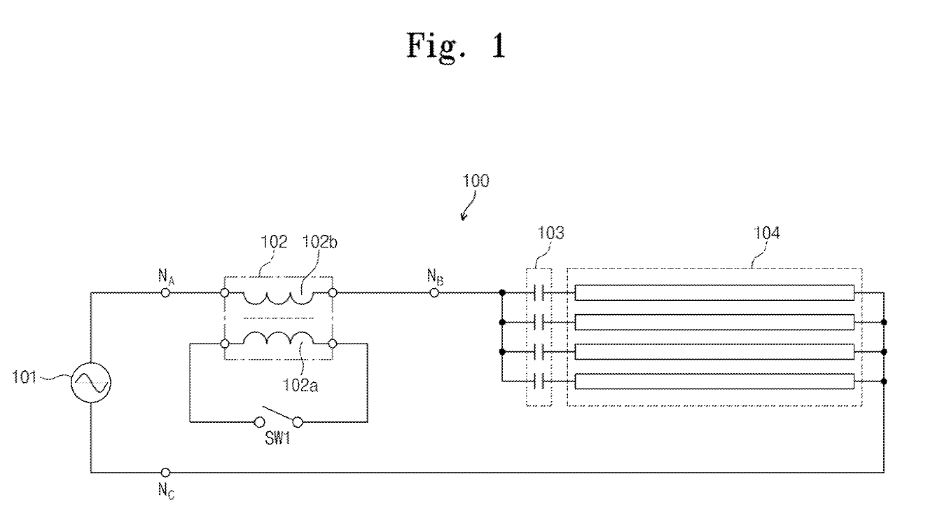

FIG. 1 is a circuit diagram schematically showing a backlight unit 100 according to an embodiment of the present disclosure.

Referring to FIG. 1, the backlight unit 100 includes a AC power source 101, an isolation transformer 102 having a primary winding 102a and a secondary winding 102b that is DC wise isolated from the primary, an electronically controlled switch SW1, a plurality of capacitors (also hereafter, condensers circuit 103), and a plurality of cold cathode fluorescent lamps (CCFL) block 104. The condensers circuit 103 includes a plurality of balancing capacitors (BCs) structured and arranged to uniformly distribute the high voltage AC power which has been output from the AC power source 101 and through the isolation transformer 102 to the plurality of CCFLs in the CCFL block 104.

In the backlight unit 100, a secondary winding 102b (at the side of the applied high voltage AC) of the isolation transformer 102 is connected to an output terminal of the AC power source 101 and is connected in series to the condensers circuit 103 and CCFL block 104. On the other hand, a primary winding 102a (at an isolated low voltage side of transformer 102) is connected to the switch SW1. Since the primary winding 102a has been isolated from the secondary winding 102b in the above structure, the switch SW1 having a low voltage stress characteristic can be used to open or short the primary winding 102a For this reason, because the relatively low voltage AC signal develops across the secondary 102b in the open switch state, the switch SW1 can be realized in a small size and of a design that does not need to feature resistance to breakdown at high voltage values such that the price and/or size of the switch can be reduced relative to switches that need to avoid breakdown at relatively higher voltage values. The isolation transformer 102 of the backlight unit 100 is a magnetic leakage type transformer in which primary and secondary windings are loosely rather than tightly magnetically coupled, and thus opening of the primary winding 102a acts to reduce the value of the high voltage AC signal applied to the CCFL block 104 because a large AC voltage drop (corresponding to a large impedance or Hi-Z state) develops across the secondary 102b when the primary 102a is open. On the other hand, when the primary 102a is shorted, a very small or essentially zero AC voltage drop develops across the secondary 102b (corresponding to a low impedance or Low-Z state of the primary) so that driving efficiency is not impaired by the secondary 102b being disposed in series between the AC source 101 and the load 103/104.

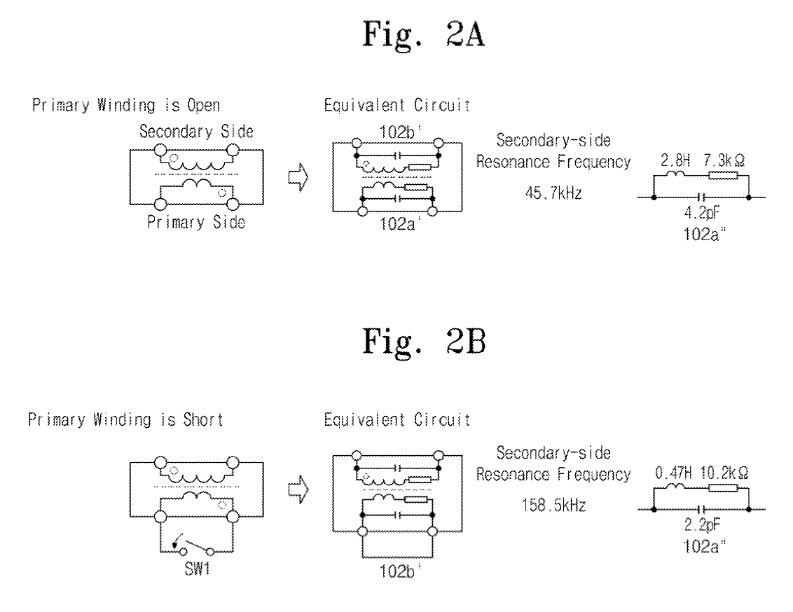

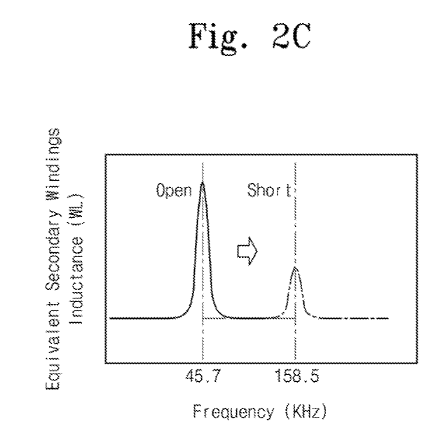

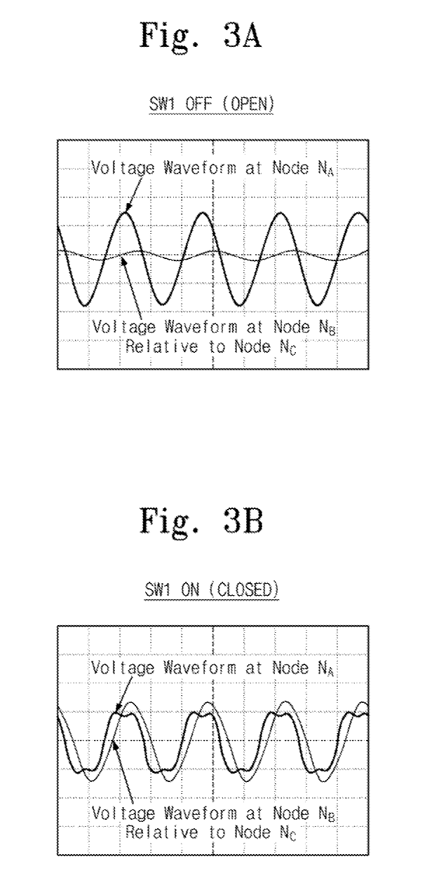

Hereinafter, the operating procedure of using the backlight unit 100 shown in FIG. 1 when the switch SW1 opens or shorts the primary winding 102a of the isolation transformer 102 will be briefly described with reference to FIGS. 2A, 2B, 2C, and 3.

FIG. 2A is an equivalent circuit diagram showing how the secondary side impedance (Z₁) is a function of a resonant frequency of the equivalent RLC circuit and in the case where a roughly 159 KHz AC signal is sourced in the series circuit of the secondary winding 102b, when the primary winding 102a of the isolation transformer 102 is left open (not short circuited), the secondary winding 102b side has an equivalent resonant frequency at about 46 KHz and thus presents itself as a high impedance (Hi-Z) in the primary series circuit. On the other hand, in FIG. 2B, in the case where the primary winding 102a is shorted, the equivalent RLC circuit of the secondary winding side 102b is about 159 KHz and the secondary side winding thus presents itself as a low impedance (Low-Z) in the primary series circuit. FIG. 2C is a graph showing the impedance variation in terms of the effective resonant frequency of the equivalent RLC circuit of the secondary winding side 102b. In other words, when the switch SW1 is open, the resonant frequency is low but the equivalent winding inductance (WL) is high. On the other hand, when the switch SW1 is closed, the resonant frequency is high and the equivalent winding inductance (WL) is low. Referring to FIG. 2A, when the primary winding 102a of the isolation transformer 102 is opened, an equivalent circuit may be constructed as a RLC parallel resonant circuit. In the RLC parallel resonant circuit, a secondary-side inductance value is about 2.8 [H] (in Henrys), a secondary-side capacitance value is about 4.2 [pF] (in picoFarads), and a secondary-side resistance value is about 7.3 [kΩ] (in kilo ohms) Accordingly, a resonance frequency of about 45.7 [kHz] is calculated based on the values of the RLC equivalent circuit components.

Referring to FIG. 2B, when the primary winding 102a of the isolation transformer 102 is shorted, an equivalent circuit may be constructed as an RLC parallel resonant circuit. In the RLC parallel resonant circuit of the short circuited case, an inductance value is about 0.47 [H], a capacitance value is about 2.2 [pF], and a resistance value is about 10.2 [kΩ]. Accordingly, a resonance frequency of about 158.5 [kHz] is calculated based on the values of the RLC equivalent circuit components.

In other words, when the switch SW1 is turned “off” and thus represents an open circuit connected to the primary winding 102a, the secondary-side equivalent circuit includes a large inductance of about 2.8 [H]. On the other hand, when the switch SW1 is turned “on” to thus short the primary winding, a substantially smaller inductance of about 0.47 [H] appears as part of the equivalent circuit impedance of the secondary winding. Accordingly, the relation between the resonance frequency of a high frequency AC voltage applied to the CCFL block 104 through the isolation transformer 102 and the equivalent circuit impedance in the secondary winding when the primary winding is opened or shorted varies as is shown in FIG. 2C.

More specifically, and as shown in FIG. 2C, when the primary winding is opened, the equivalent circuit of the secondary winding takes on a relatively low resonant frequency and a relatively large inductance (ωL). On the other hand, when the secondary winding is shorted, the equivalent circuit of the secondary winding takes on a relatively high resonant frequency and a relatively smaller inductance value, where the higher resonant frequency is much nearer to a turn-on frequency of the AC source 101 than is the low resonant frequency. Accordingly, the CCFL 104 is not turned on when the low resonant frequency, high inductance state occurs. Stated otherwise, the high frequency AC voltage of the source is applied to the CCFL block 104 only after having been reduced by a drop across the high inductance presented by the primary-side impedance of the isolation transformer 102 relative to the impedance of the CCFL block 104. Accordingly, the high frequency AC voltage that develops across to the CCFL block 104 when the switch SW1 is open, is less than a predetermined high voltage need to turn on the CCFL block 104 (to ignite the gases in the lamps into plasma states), and so that the CCFL block 104 is not turned on.

By contrast, and as also shown in FIG. 2C, when the primary winding 102a is shorted by a turned “on” state of the switch SW1, a resonance frequency of the secondary side equivalent circuit is increased, and the equivalent circuit inductance (ωL) presented by the secondary side of the transformer is decreased at the operating frequency of the CCFL 104. Accordingly, a large AC voltage drop does not develop across the secondary winding 102b and the CCFL block 104 is turned on. In other words, since the secondary-side impedance value is reduced in the switch SW1 closed state, the high frequency AC voltage applied across the CCFL block 104 becomes greater than or equal to the predetermined voltage needed to initiate the turning on of the lamps in the CCFL block 104, so that the CCFL block 104 is therefore turned on.

FIG. 3A is a view showing voltage waveforms at nodes N_{A} and N_{B} relative to common node Nc in the case when the switch SW1 is turned off (left open). FIG. 3B is a view showing voltage waveforms at the nodes N_{A} and N_{B} when the switch SW1 is turned on (placed into a short circuiting state). As shown in FIGS. 3A and 3B, when the switch SW1 is turned off to leave open the primary winding 102a, the voltage value of the node N_{B} is decreased due to the voltage drop across the secondary winding and as a result, the CCFL block 104 is not turned on. On the other hand, when the switch SW1 is turned on to thereby provide a short circuit across the primary winding 102a, the voltage value of node N_{B} is increased sufficiently so that the CCFL block 104 is turned on.

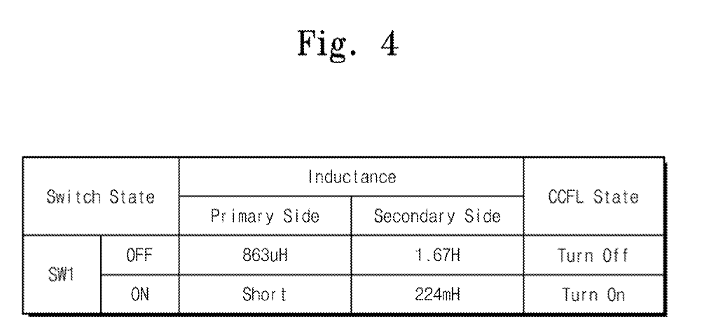

FIG. 4 is a table showing the relations between the variation in impedance values of the primary and secondary windings of the isolation transformer 102 and the operating state of the CCFL block 104 when the switch SW1 is turned on or off.

As described above, when the switch SW1 is turned on or turned off, the inductance value of the secondary winding is changed from about 1.67 [H] to about 224 [mH], so that the CCFL block 104 is changed from a turn-off operation state to a turn-on operation state. The CCFL block 104 can be turned on by matching a resonance frequency of a LC series resonant circuit, which is derived from leakage inductance and capacitance of a balance condenser (BC) when the primary winding is shorted, with an inverter frequency. The CCFLs are driven through series resonance occurring by the LC series resonant circuit, so that a capacitance component and an inductance component are offset with each other in the turn-on state, and only a resistance component serves as a load, thereby reducing the value of the high AC voltage applied to the CCFL block 104.

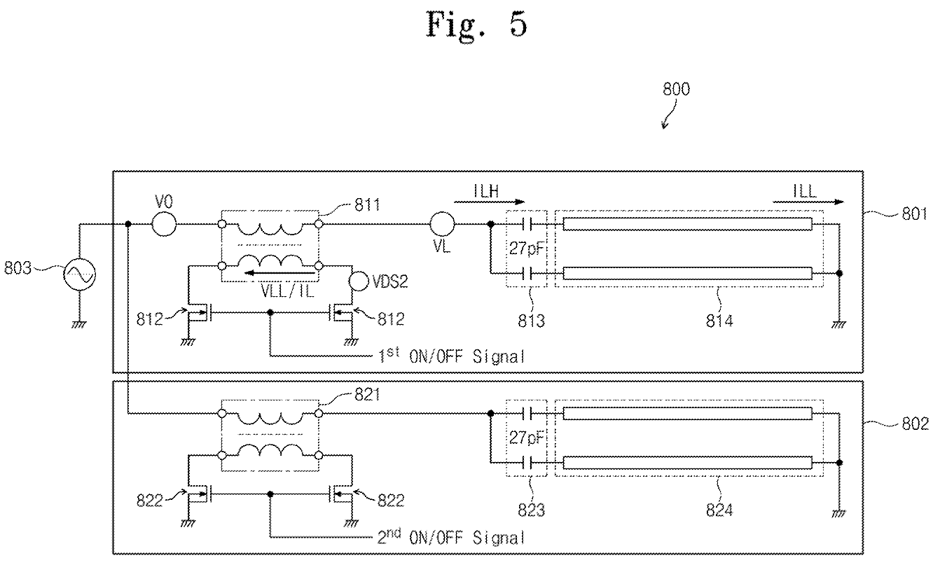

Hereinafter, a detailed circuit diagram of a backlight unit 800 using a series of LC resonant circuits will be described with reference to FIG. 5.

Referring to FIG. 5, the backlight unit 800 includes a first backlight section 801, a second backlight section 802, and a high voltage, high frequency AC power source 803. The first and second backlight sections 801 and 802 are connected in parallel an out terminal of the AC power source 803.

The first backlight section 801 includes a first high frequency isolation transformer 811, a first pair of MOSFETs 812 forming a first low voltage switching element, a first condensers circuit 813, and a first CCFL block 814. The second backlight section 802 includes a corresponding second isolation transformer 821, a second set of MOSFETs 822 serving as a second switch element, a second condensers circuit 823, and a second CCFL block 824. As seen, the first and second backlight sections 801 and 802 have substantially the same circuit configuration except that each is controlled by a respective low voltage ON/OFF control signal.

Each BC in the condenser circuits 813 and 823 has a capacitance value of 27 [pF], and each CCFL in the CCFL blocks 814 and 824 has a length of 52 inches. Of course, other values may be used in other variations of the basic circuit concept. The capacitance values of the BC's is a parameter that operates to determine a resonance frequency of an equivalent LC series circuit and the BC value may be set in accordance with consideration of matching impedances based on the inverter operating frequency. Thus, the capacitance values of the BC's and the lengths of the CCFL's are not limited to those disclosed for the present embodiment.

The switch operation of the first FETs 812 is controlled through a first ON/OFF control signal provided from an external operation controller (e.g., a low voltage microcontroller circuit, not shown). Through the switching operation of the first FETs 812, a primary winding of the first isolation transformer 811 is selectively shorted or opened. The switch operation of the second FETs 822 is similarly controlled through a second ON/OFF control signal provided from the external operation controller. Through the switching operation of the second FETs 822, a primary winding of the second isolation transformer 821 is selectively shorted or opened.

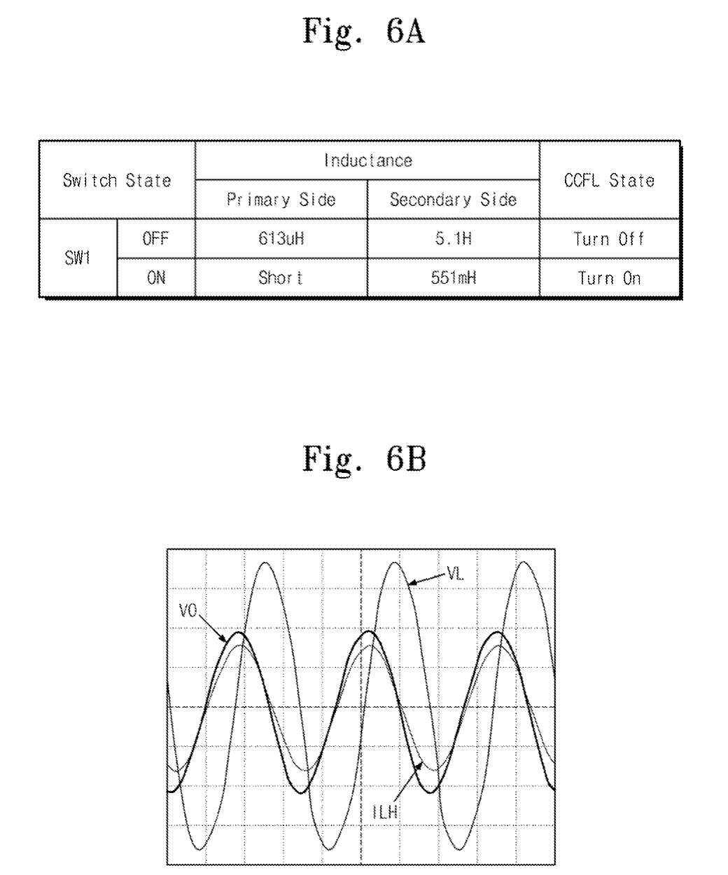

Hereinafter, the turn-on operation of the first backlight section 801 will be described with reference to FIGS. 6A and 6B.

FIG. 6A is a table view showing the relations between the variation in inductance values of the primary and secondary windings of the first isolation transformer 811 and the corresponding operating state of the first CCFL block 814 when the first pair of MOSFETs 812 are turned off or on by application of a low voltage control signal to their isolated gate electrodes. FIG. 6B is an oscilloscope type view showing high frequency AC voltage waveforms and current waveforms that develop at and through nodes V0 and VL of FIG. 5 relative to ground. The illustrated variation in load current ILH of the high voltage circuit is that which is applied to an input terminal of the first CCFL block 814. On the other hand, the illustrated current ILL is that which is output from an output terminal of the first CCFL block 814.

If the first FETs 812 are turned on to thereby substantially short circuit the terminals of the primary winding of the first isolation transformer 811, a LC series resonant circuit having leakage inductance in the primary winding of the isolation transformer 811 if formed and the capacitance of the BC performs a resonance operation for coupling the power source energy to the lamps. Through such a matched resonance operation of the LC series circuitry, the voltage VL of the load node, as shown in FIG. 6, becomes a high frequency AC voltage that is greater than or equal to the voltage needed to initiate the turning-on of the gas lamps in the first CCFL block 814.

Referring to FIG. 5, on the assumption that the secondary inverter frequency (f) is about 30 [kHz], a resonance frequency (f0) when the primary winding is shorted is calculated from following Equation 1.

$$fo = \frac{1}{2 {π ( L \times C )}^{\frac{1}{2}}} \qquad Equation 1$$

In Equation 1, L refers to a secondary-side inductance value, and C refers to a secondary-side capacitance value. In this case, when the primary winding is shorted, the secondary side equivalent circuit inductance, L becomes 551 [milliH] (see FIG. 6A), and the secondary side equivalent circuit capacitance C becomes 27 [pF]×2 (because the two BC's are basically in parallel with one another once their lamps ignite). The resonance frequency (f0) of the secondary side LC series resonant circuit then becomes about 29.2 [kHz] as shown in following Equation 2 to thereby substantially match the fundamental operating frequency of the power source 803.

$$fo = \frac{1}{2 {π ( 551 mH \times 27 pF \times 2 )}^{\frac{1}{2}} } = 29.2 [ kHz ] \qquad Equation 2$$

In order to allow the impedance of the first CCFL block 814, which is loaded as the LC series resonant circuit is operated at the resonance frequency (f0) of about 30 kHz to appear only as resistance component (R), voltage applied to the first CCFL block 814 is obtained based on following Q factor Equation 3.

$$Q = \frac{Z L}{R} = \frac{1}{ZCR} = \frac{( 2 π \times f \times L )}{R} = \frac{1}{2 π \times f \times C \times R} \qquad Equation 3$$

In Equation 3, ‘f’ refers to the high voltage lamps driving frequency, and ‘R’ refers to a resistance component of the CCFL block 814. In this case, if the resistance component (R) has a value of 92 [kΩ], and the L becomes 551 [mH] (see FIG. 6A), where the latter is the secondary-side inductance value when the primary winding is shorted, then accordingly, the AC operating voltage applied to the CCFL block 814 becomes 2.14 by the LC series resonant circuit operating at the resonance frequency (f0) as shown in Equation 4.

$$Q = \frac{( 2 π \times 30 [ kHz ] \times 551 [ mH ]}{( \frac{92 k Ω}{2} ) } \approx 2.14 \qquad Equation 4$$

When the voltage is applied to the first CCFL block 814 by the LC series resonant circuit operating at the resonance frequency (f0), the voltage V0 at the node V0 and the current ILH flowing through the first CCFL block 814, which are shown in FIG. 5, are substantially in phase as shown in FIG. 6B, and the high AC voltage applied to the first CCFL block 814 by the LC series resonant circuit can be lowered. Accordingly, the driving efficiency can be improved. Meanwhile, the second backlight section 802 has the same turn-on/turn-off operation as that of the first backlight section 801.

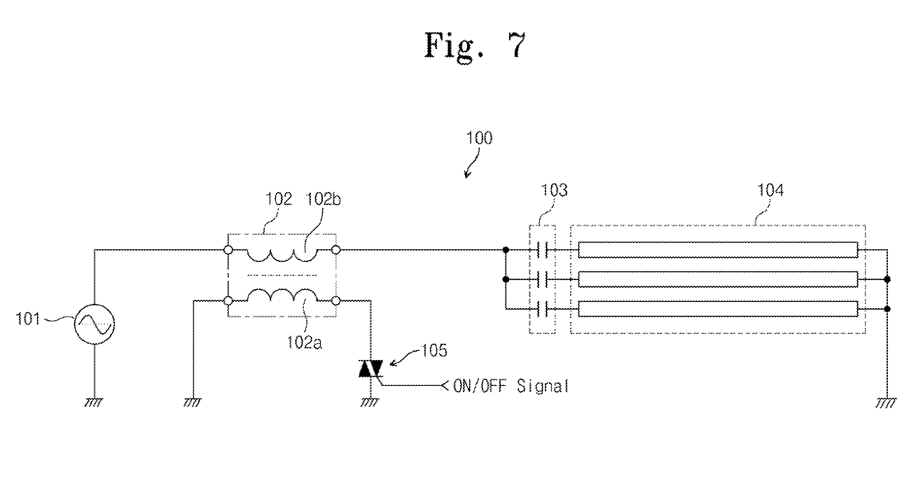

In addition, according to the present disclosure, time to turn on the first CCFL block 814 can be controlled through the switching operation of the switch SW1 to open or short the primary winding of the isolation transformer 811. Hereinafter, detailed possible structures for the switch SW1 will be described with reference to FIGS. 7 to 9. Meanwhile, the same reference numerals will designated to elements of FIGS. 7 to 9 identical to those of FIG. 1.

FIG. 7 is a circuit diagram showing a structure in which an AC triode switch (a TRIAC) 105 is provided as the switch SW1.

In this case, an ON/OFF control signal can be input to a trigger terminal of the TRIAC 105 from an external control circuit to turn on/turn off the TRIAC 105, thereby changing the turn-on/turn-off state of the CCFL block 104.

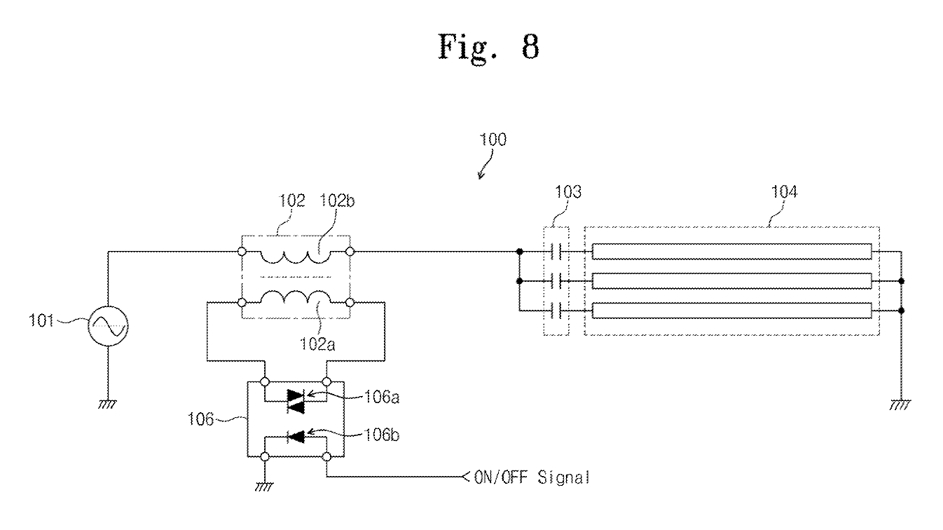

In the embodiment of FIG. 8 a photo-coupled TRIAC 106 is provided as the switch SW1. The photo-TRIAC 106 includes a light-sensitive TRIAC part 106a and a light emitting diode (LED) 106b (e.g., IR emitting diode) that is optically coupled to the TRIAC trigger layers instead of by way of direct trigger electrodes. The optical coupling of the light emitting diode 106b to the photosensitive part 106a is understood to be a high voltage isolation coupling.

An ON/OFF signal is input to the LED 106b from an external control circuit to turn on or off the light-sensitive TRIAC part 106a, thereby turning on or off the photo-TRIAC 106 such that the turn-on/turn-off state of the CCFL block 104 can be changed.

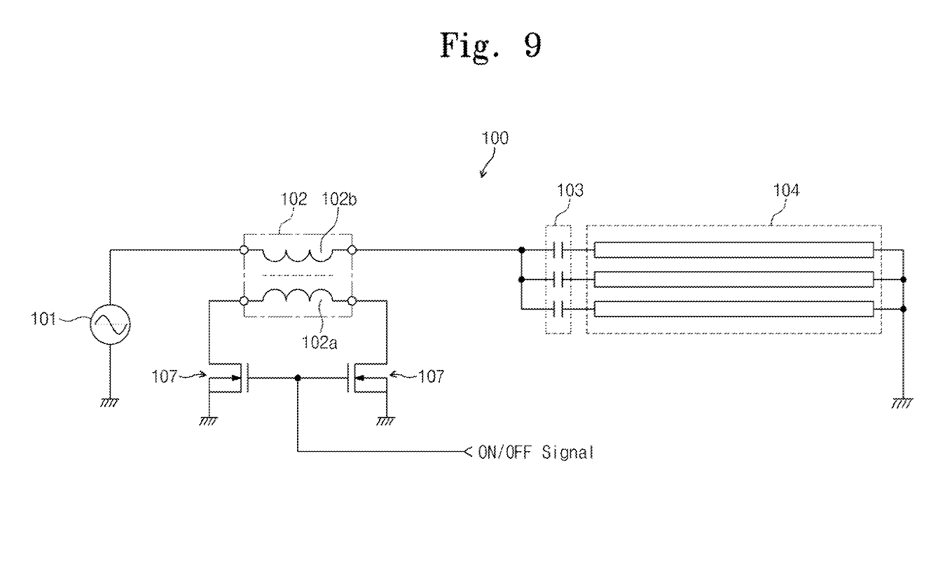

FIG. 9 is a circuit diagram showing a structure in which two MOSFETs 107 are connected as shown to form the switch SW1. Here, each of MOSFETs 107 takes half the voltage stress when the primary side is in the open circuit state. Also, the control voltage applied to the gates of the MOSFETs 107 to switch them into the conductive state can be relatively low. In this case, an ON/OFF signal can be input to gate terminals of the FETs 107 from an external control circuit to turn on or off the FETs 107, thereby changing the turn-on/turn-off state of the CCFL block 104.

Each switching operation of the TRIAC 105, or the photo-TRIAC 106, or the tandem FETs 107 shown in respective FIGS. 7 to 9 and serving as the switch SW1 is controlled by the ON/OFF control signal having a relatively low voltage and being well isolated from the high voltage side of the circuitry. In other words, in order to prevent high AC voltage from being applied to the primary winding of the isolation transformer 102, the backlight unit 100 according to one embodiment of the present disclosure can employ a semiconductor switching device operable at low voltage as the switch SW1.

Thus, since the backlight unit 100 can employ the semiconductor switching device operable at low voltage, the switch SW1 can be realized in a small size, and low-voltage operation can be realized. In addition, a higher-speed switching operation can be realized as compared with a switching operation of a high voltage switch. Accordingly, the backlight unit 100 can perform a switch function (scanning control function or dynamic local dimming function for each block) at a high speed suitable for controlling the luminance of the displayed image portion of that backlighting block upon the turn-on/turn-off operation for each CCFL block.

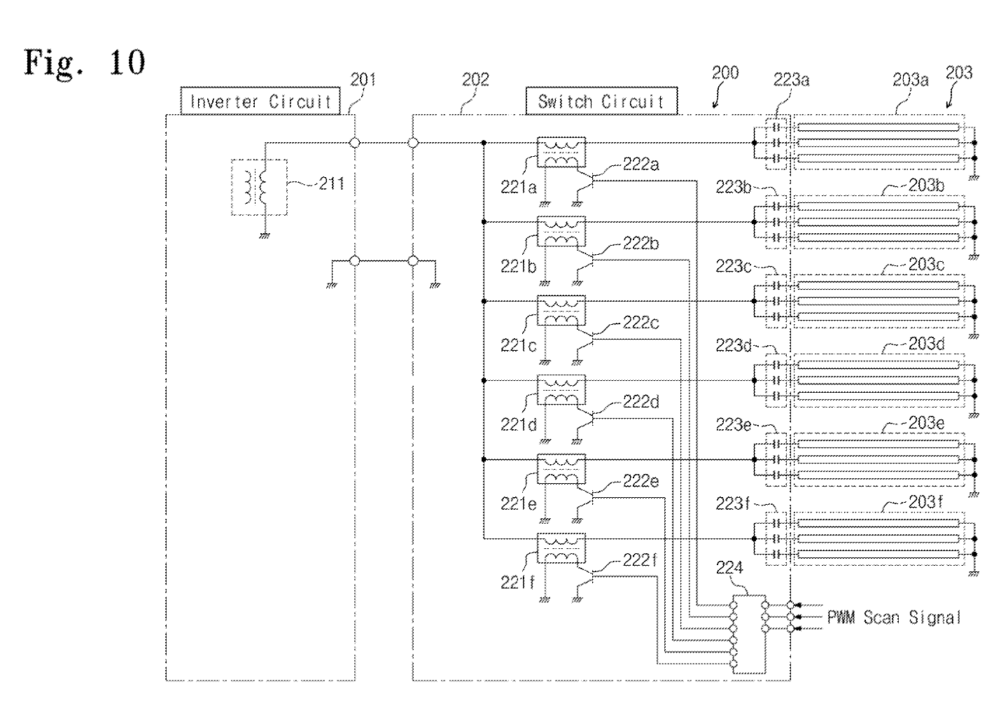

Hereinafter, a circuit configuration of a backlight unit 200 according to one embodiment of the present disclosure will be described in detail with reference to FIG. 10.

Referring to FIG. 10, the backlight unit 200 includes an inverter circuit section 201, a switch circuits section 202, and a CCFL block groups section 203. The inverter circuit section 201 includes a power transformer 211 to provide supply high frequency, high voltage AC signal to the switch circuits section 202. The CCFL block groups section 203 includes respective CCFL blocks 203a to 203f. Each of the CCFL blocks 203a to 203f includes three CCFLs.

The switch circuits section 202 includes respective isolation transformers denoted as 221a to 221f, corresponding switching transistors (or other switching elements) 222a to 222f, and condenser circuits 223a to 223f, which correspond to the CCFL blocks 203a to 203f in number, and a control circuit 224 operatively coupled to the switching elements 222a to 222f.

Secondary windings of the isolation transformers 221a to 221f are connected between an output terminal of the power source transformer 211 and input terminals of the condenser circuits 223a to 223f, respectively, in series. First ends of primary windings of the isolation transformers 221a to 221f are grounded at one end, and second ends of the primary windings of the isolation transformers 221a to 221f are connected to the corresponding switching transistors 222a to 222f, respectively. A base terminal of each of the illustrated bipolar switching transistors 222a to 222f is connected to the control circuit 224. (But as mentioned, other forms of switching elements may be used for items 222a to 222f.) The switching transistors 222a to 222f perform a switching operation by an ON/OFF signal input through the base terminal connected to the control circuit 224 so that the primary windings are shorted or opened.

The condenser circuits 223a to 223f include a plurality of BCs to uniformly distribute the high frequency AC voltage signals which are output through the isolation transformers 221a to 221f, to the plurality of CCFLs provided in the CCFL blocks 203a to 203f.

The control circuit 224 generates the ON/OFF signal used to time-division multiplex-wise control the turn-on/turn-off operation modes and phases of the CCFL blocks 203a to 203f based on a PWM (pulse width modulated) scan control signal provided from an external operation control circuit (e.g., microcontroller, not shown) for the backlight unit, and outputs the ON/OFF signal to the base terminal of each of the switching transistors 222a to 222f.

If the respective switching transistors 222a to 222f are in corresponding OFF states, the respective primary windings of the isolation transformers 221a to 221f attain an opened circuit state. On the other hand, if the switching transistors 222a to 222f are in an ON state, the corresponding primary windings of the isolation transformers 221a to 221f become shorted. Accordingly, the control circuit 224 can time-division wise control the ON/Off states of the individual CCFL blocks 203a to 203f by controlling ON/OFF operation time of the switching transistors 222a to 222f based on the PWM scan signals applied to respective input terminals of control circuit 224. (In an alternate embodiment, the input terminals of control circuit 224 receive digital control signals indicated duty cycles to be attained for respective ones of the individual CCFL blocks 203a to 203f and the control circuit 224 generates corresponding PWM control signals for application to switching elements 222a to 222f.)

As described above, in the backlight units 100 and 200 according to one embodiment of the present disclosure, the primary windings (at the side of low-voltage) of the isolation transformers 102 and 221a to 221f are opened/shorted through the switching operation of the switches SW1 and the switching transistors 222a to 222f, thereby allowing for duty cycle or other time-division controlling of the turn-on/turn-off operation time of the high frequency driven CCFL blocks 203a to 203f and thus controlling the apparent luminance of the respective CCFL blocks 203a to 203f. In addition, an LC series resonant circuit is constructed by leakage inductance of the isolation transformers 102 and 221a to 221f and capacitance of a BC, and the CCFL blocks 104 and 203a to 203f are turned on through the series resonance of the LC series resonant circuit. Accordingly, the value of high AC voltage applied to the CCFL blocks 104 and 203a to 203f can be lowered by employing only a resistance component as a load in turning on the CCFL blocks 104 and 203a to 203f.

Accordingly, the voltage stress of a switch circuit can be reduced. In addition, the isolation transformers 102 and 221a to 221f, the switch SW1, and the switching transistors 222a to 222f having a low voltage stress characteristic are used, so that small-size and low-price switch circuits having low power consumption can be realized. The cost of a backlight unit employing the switch circuit can be reduced.

In particular, since high AC voltage is not directly applied to the switch SW1 and more specifically, to the collectors or drains of the switching transistors 222a to 223f to open or short the corresponding primary windings of the isolation transformers 221a to 221f, then semiconductor switching devices operating at low voltage can be used, a small-size and low-price backlight unit having low power consumption can be realized.

Although the switching transformers 222a to 222f are used in the switching circuit 202 shown in FIG. 10, a semiconductor switching device such as the TRIAC 105, the photo-TRIAC 106, or the MOSFETs 107 can be used instead of the bipolar switching transistors 222a to 222f as shown in FIGS. 7 to 9. If the semiconductor switching device is employed when the backlight unit 200 according to one embodiment of the present disclosure is adapted to the LCD which will be described later, a function (scanning control function or dynamic local dimming function for each block) to switch the turn-on/turn-off state of CCFL blocks at a high speed in a block unit can be performed to represent the maximum brightness of a displayed image area according to the brightness of an input image for that area. Accordingly, the image quality and/or power consumption efficiency of the LCD can be improved.

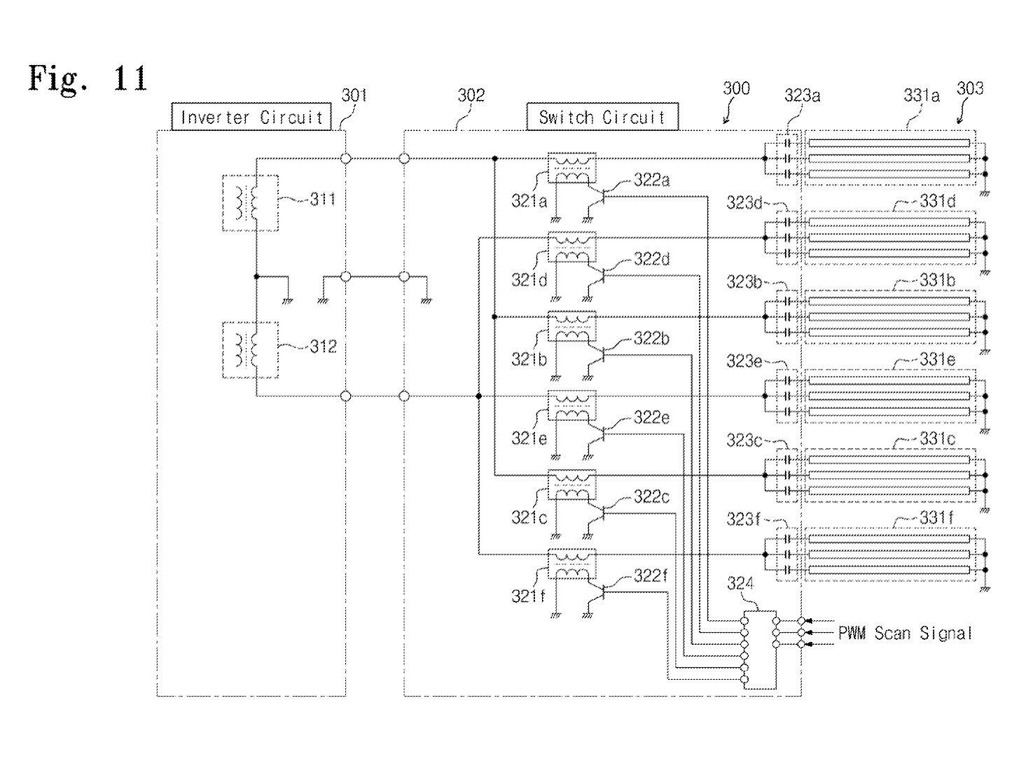

FIG. 11 is a circuit diagram showing a backlight unit 300 according to another embodiment of the present disclosure.

Referring to FIG. 11, the backlight unit 300 includes an inverter circuit section 301, a switch circuits section 302, and a CCFL blocks group 303. The CCFL blocks group 303 includes CCFL blocks 331a to 331f. Each of the CCFL blocks 331a to 331f includes three CCFLs. A first phase or “normal”-phase high frequency high voltage AC signal is applied to the odd numbered CCFL blocks 331a to 331c (normal-phase CCFL blocks), and a differently phased, for example inverse-phase high frequency, high voltage AC signal is applied to the interdigitated and even numbered CCFL blocks 331d to 331f (inverse-phase CCFL blocks).

The inverter circuit section 301 includes a normal-phase power outputting transformer 311 and an inverse-phase power outputting transformer 312. The normal-phase power transformer 311 supplies the normal-phase high AC voltage signal to the odd-number wise ordered parts of the switch circuit 302, and the inverse-phase power transformer 312 supplies the inverse-phase high AC voltage signal to the even-number number wise ordered parts of the switch circuit 302.

The switch circuits section 302 thus includes normal-phase isolation transformers 321a to 321c, inverse-phase isolation transformers 321d to 321f, normal-phase switching transistors 322a to 322c, inverse-phase switching transistors 322d to 322f, condenser circuits 323a to 323f, and a control circuit 324.

Secondary windings of the normal-phase isolation transformers 321a to 321c are connected between an output terminal of the normal-phase power transformer 311 and input terminals of the condenser circuits 323a to 323c, respectively, in series. First ends of primary windings of the normal-phase isolation transformers 321a to 321c are grounded, and second ends of the primary windings are connected to the normal-phase switching transistors 322a to 322c, respectively.

Secondary windings of the inverse-phase isolation transformers 321d to 321f are connected between an output terminal of the inverse-phase power transformer 312 and input terminals of the condenser circuits 323d to 323f, respectively, in series. First ends of primary windings of the inverse-phase isolation transformers 321d to 321f are grounded, and second ends of the primary windings are connected to the inverse-phase switching transistors 322d to 322f, respectively.

A base terminal of each of the normal-phase switching transistors 322a to 322c is connected to the control circuit 324. The normal-phase switching transistors 322a to 322c receive an ON/OFF signal for a normal-phase operation from the control circuit 324 through the base terminals (or alternatively gate electrodes) to perform the desired switching operations at appropriate time points, thereby shorting or opening the primary windings of the normal-phase isolation transformers 321a to 321c.

A base terminal of each of the inverse-phase switching transistors 322d to 322f is connected to the control circuit 324. The inverse-phase switching transistors 322d to 322f receive an ON/OFF signal for an inverse-phase operation from the control circuit 324 through the base terminal to perform a switching operation, thereby shorting or opening the primary windings of the inverse-phase isolation transformers 321d to 321f.

The condenser circuits 323a to 323f include a plurality of BCs to uniformly distribute normal-phase high AC voltage, which is output from the normal-phase isolation transformers 321a to 321c, and inverse-phase high AC voltage, which is output from the inverse-phase isolation transformers 321d to 321f, to a plurality of CCFLs in the CCFL blocks 331a to 331f.

The control circuit 324 generates the ON/OFF signal used to time-division wise control the duty cycles and the turn on and off times the CCFL blocks 331a to 331f based on a PWM scan signal provided from an external operation control circuit (not shown) for a backlight unit, and outputs the ON/OFF signal to the base terminal, and outputs the ON/OFF signal to the base terminals of the normal-phase switching transistors 322a to 322c and the inverse-phase switching transistors 322d to 322f.

When the normal-phase switching transistors 322a to 322c are in an off state, the primary windings of the normal-phase isolation transformers 321a to 321c are opened. When the normal-phase switching transistors 322a to 322c are in an on state, the primary windings of the normal-phase isolation transformers 321a to 321c are shorted. Accordingly, the control circuit 324 controls an on/off operation time of the normal-phase switching transistors 322a to 322c based on the PWM scan signal to time-division control the turn-on/turn-off operation time of the CCFL blocks 331a to 331c.

When the inverse-phase switching transistors 322d to 322f are in the off state, the primary windings of the inverse-phase isolation transformers 321d to 321f are opened. When the inverse-phase switching transistors 322d to 322f are in the on state, the primary windings of the inverse-phase isolation transformers 321d to 321f are shorted. Accordingly, the control circuit 324 controls an on/off operation time of the inverse-phase switching transistors 322d to 322f based on the PWM scan signal to time-division control the turn-on/turn-off operation time of the CCFL blocks 331d to 331f.

Since the CCFL blocks 331a to 331c to receive normal-phase high AC voltage are alternately interposed with the CCFL blocks 331d to 331f to receive inverse-phase high AC voltage in the backlight unit 300 shown in FIG. 11, noise components between adjacent CCFL blocks can be offset with each other because one lamp will be receiving a positive going noise spike, if so present in the high voltage power signal and the next adjacent lamp will be receiving a negative going noise spike, if so present. Accordingly, the quality of a display image can be improved by employing out of phase lamp drive signals.

Since the primary side switches are in the low voltage portions of the isolation transformers, accordingly, in the backlight unit 300 shown in FIG. 11, the voltage stress of each switch circuit can be reduced, and the normal-phase isolation transformers 321a to 321c, the inverse-phase isolation transformers 321d to 321f, the normal-phase switching transistors 322a to 322c, and the inverse-phase switching transistors 322d to 322f having a low voltage stress characteristic can be used, so that small-size and low-price switch circuits having low power consumption can be realized. Accordingly, the power consumption, size, and price of a backlight unit employing the switch circuits can be also reduced.

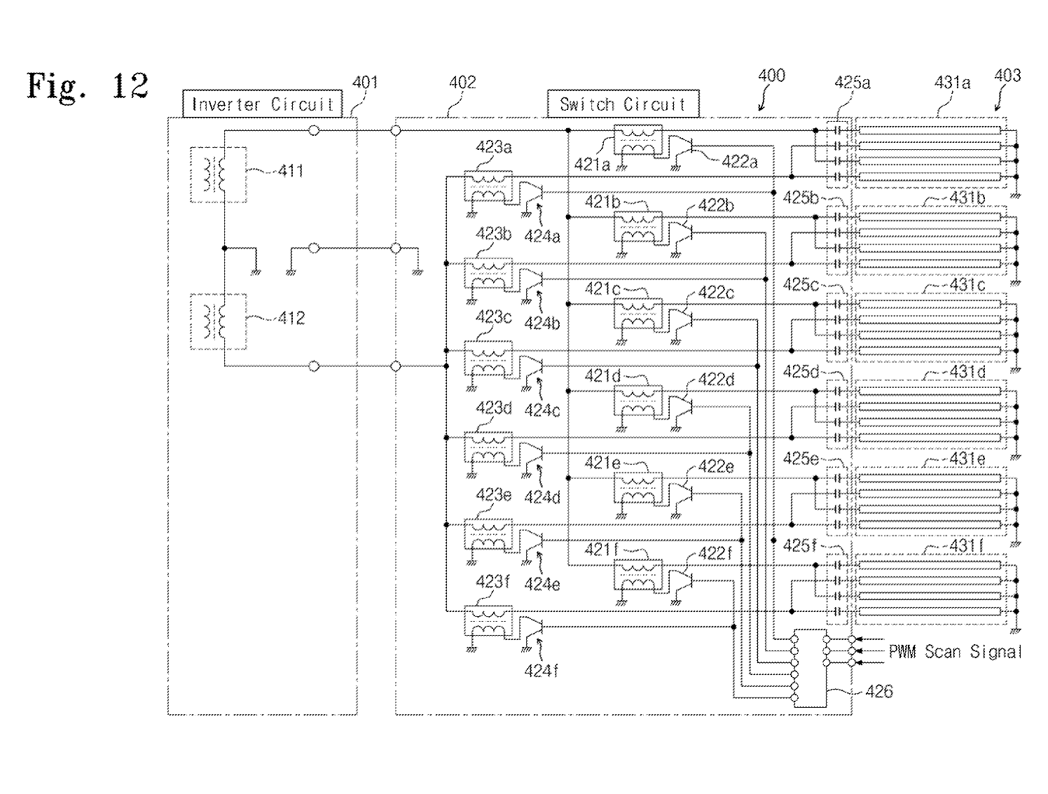

FIG. 12 is a circuit diagram showing a backlight unit 400 in which CCFLs of receiving normal-phase high AC voltage are alternately aligned with CCFLs of receiving inverse-phase high AC voltage. Moreover, the balancing condensers (BC's) in each lamp block are alternatively connected as shown.

Referring to FIG. 12, the backlight unit 400 includes an inverter circuit 401, a switch circuit 402, and a CCFL block group 403. The CCFL block group 403 includes CCFL blocks 431a to 431f. Each of the CCFL blocks 431a to 431 includes four CCFLs. In each of the CCFL blocks 431a to 431f, half the CCFLs are connected to receive the normal-phase high AC voltage signal and the other half are connected to alternately receive the out of phase (e.g., inverse phase) high AC voltage signal.

The high voltage lamps driving circuit 401 includes a normal-phase power transformer 411 and an inverse-phase power transformer 412. The normal-phase power transformer 411 supplies normal-phase high AC voltage signal to the switch circuit 402.

The inverse-phase power transformer 412 supplies differently phased (e.g., inverse-phase) high AC voltage signal to the switch circuit 402.

The switch circuit 402 includes normal-phase isolation transformers 421a to 421f, inverse-phase isolation transformers 423a to 423f, normal-phase switching transistors 422a to 422f, inverse-phase switching transistors 424a to 424f, condenser circuits 425a to 425f, and a control circuit 426.

Secondary windings of the normal-phase isolation transformers 421a to 421f are connected between an output terminal of the normal-phase power transformer 411 and input terminals of the condenser circuits 425a to 425f, respectively, in series. First ends of primary windings of the normal-phase isolation transformers 421a to 421f are grounded, and second ends of the primary windings are connected to the normal-phase switching transistors 422a to 422f, respectively.

Secondary windings of the inverse-phase isolation transformers 423a to 423f are connected between an output terminal of the inverse-phase power transformer 412 and the input terminals of the condenser circuits 425a to 425f, respectively, in series. First ends of primary windings of the inverse-phase isolation transformers 423a to 423f are grounded, and second ends of the primary windings are connected to the inverse-phase switching transistors 424a to 424f, respectively.

A base terminal of each of the normal-phase switching transistors 422a to 422f is connected to the control circuit 426. The normal-phase switching transistors 422a to 422f receive an ON/OFF signal for a normal-phase operation from the control circuit 426 through the base terminal to perform a switching operation, thereby shorting or opening the primary windings of the normal-phase isolation transformers 421a to 421f.

A base terminal of each of the inverse-phase switching transistors 424a to 424f is connected to the control circuit 426. The inverse-phase switching transistors 424a to 424f receive an ON/OFF signal for an inverse-phase operation from the control circuit 426 through the base terminal and perform a switching operation in response to the ON/OFF signal to short or open the primary windings of the inverse-phase isolation transformers 423a to 423f.

The condenser circuits 425a to 425f include a plurality of BCs to uniformly distribute normal-phase high AC voltage signal, which is output from the normal-phase isolation transformers 421a to 421f, or the inverse-phase high AC voltage signal, which is output from the inverse-phase isolation transformers 423a to 423f, to a plurality of CCFLs in the CCFL blocks 431a to 431f.

The control circuit 426 generates the ON/OFF signal used to time-division control time to turn on the CCFL blocks 431a to 431f based on a PWM scan signal provided from an external operation control circuit (not shown) for a backlight unit, and outputs the ON/OFF signal to the base terminals of the normal-phase switching transistors 422a to 422f and the inverse-phase switching transistors 424a to 424f.

When the normal-phase switching transistors 422a to 422f are in an off state, the primary windings of the normal-phase isolation transformers 421a to 421f are opened. When the normal-phase switching transistors 422a to 422f are in an on state, the primary windings of the normal-phase isolation transformers 421a to 421f are shorted. Accordingly, the control circuit 426 controls an on/off operation time of the normal-phase switching transistors 421a to 421f based on the PWM scan signal to time-division control the turn-on/turn-off time of the CCFLs that receive the normal-phase high AC voltage signal and are provided in the CCFL blocks 431a to 431f.

When the inverse-phase switching transistors 424a to 424f are in the off state, the primary windings of the inverse-phase isolation transformers 423a to 423f are opened. When the inverse-phase switching transistors 424a to 424f are in the on state, the primary windings of the inverse-phase isolation transformers 423a to 423f are shorted. Accordingly, the control circuit 426 controls an on/off operation time of the inverse-phase switching transistors 424a to 424f based on the PWM scan signal to time-division control the turn-on/turn-off operation time of the CCFLs that receive the inverse-phase high AC voltage signal and are provided in the CCFL blocks 431a to 431f

Since the backlight unit 400 shown in FIG. 12 has a circuit configuration in which an even number of (e.g., four) CCFLs are provided in each of the CCFL blocks 431a to 431f and these are alternatively connected to alternately receive the normal-phase high AC voltage signal and the differently phased (e.g., inverse-phase) high AC voltage signal, noise components between adjacent CCFL blocks may be offset with each other. Accordingly, the quality of a display image can be improved.

Accordingly, in the backlight unit 400 shown in FIG. 12, the voltage stress of a switch circuit can be reduced, and the normal-phase isolation transformers 421a to 421f, the inverse-phase isolation transformers 423a to 423f, the normal-phase switching transistors 422a to 422f, and the inverse-phase switching transistors 424a to 424f having a low voltage stress characteristic can be used, so that small-size and low-price switch circuits having low power consumption can be realized. Accordingly, the power consumption, size, and price of a backlight unit employing the switch circuits can be also reduced.

Although the switch circuits 302 and 402 shown in FIGS. 11 and 12 employ the switching transistors 322a to 322f, 422a to 422f, and 424a to 424f, semiconductor switching devices such as the TRIAC 105, the photo-sensitive TRIAC 106, and the MOSFET 107 shown in FIGS. 7 to 9 can be used. If backlight units 300 and 400 employing the semiconductor switching device are adapted to the LCD, the turn-on/turn-off state of CCFL blocks can be switched at a high speed in a block unit suitably for the brightness of an input image, thereby improving image quality.

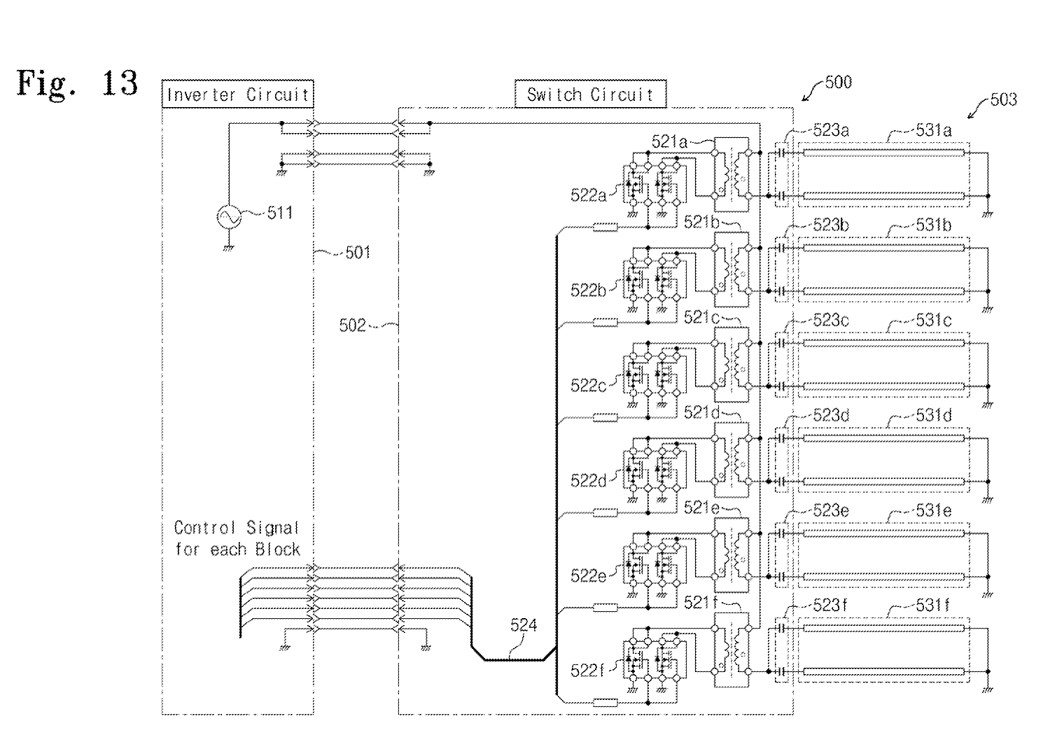

FIG. 13 is a circuit diagram showing a backlight unit 500 according to another embodiment of the present disclosure.

Referring to FIG. 13, the backlight unit 500 includes an inverter circuit 501, a switch circuit 502, and a CCFL block group 503.

The inverter circuit 501 includes an AC power source 511 to provide supply voltage to the switch circuit 502. The CCFL block group 503 includes CCFL blocks 531a to 531f. Each of the CCFL blocks 531a to 531f may include an even number of CCFL's (e.g., two CCFLs).

The switch circuit 502 includes isolation transformers 521a to 521f, semiconductor switch circuits 522a to 522f, and condenser circuits 523a to 523f that correspond to the CCFL blocks 531a to 531f in number.

A secondary winding of each of the isolation transformers 521a to 521f is connected between an output terminal of the AC power source 511 and an input terminal of each of the condenser circuits 523a to 523f, in series. Both ends of a primary winding of each of the isolation transformers 521a to 521f are connected to each of the semiconductor switch circuits 522a to 522f. Each of the semiconductor switch circuits 522a to 522f includes two MOSFETs and two kickback current routing diodes, and base terminals of the two MOSFETs are connected to an input line 524 for a block control signal. The semiconductor switch circuits 522a to 522f are provided with the input line 524 connected to an external control circuit (not shown). Each of the semiconductor switch circuits 522a to 522f receives a control signal (ON/OFF signal) for each block from the input line 524 through the base terminal to perform a switching operation, so that the primary winding is shorted or opened.

The condenser circuits 523a to 523f include a plurality of BCs to uniformly distribute high AC voltage, which is output from the isolation transformers 521a to 521f, to a plurality of CCFLs provided in the CCFL blocks 531a to 531f.

When the semiconductor switch circuits 522a to 522f are in an off state, primary windings of the isolation transformers 521a to 521f are opened. When the semiconductor switch circuits 522a to 522f are in an on state, the primary windings of the isolation transformers 521a to 521f are shorted. The on/off operation time of the semiconductor switch circuits 522a to 522f is controlled based on the control signal (ON/OFF signal) for each block, thereby time-division control the turn-on/turn-off operation time of the CCFL blocks 531a to 531f.

Accordingly, the voltage stress of a switch circuit can be reduced, and the isolation transformers 521a to 521f and the semiconductor switch circuits 522a to 522f having a low voltage stress characteristic can be used. Accordingly, the cost of a backlight unit employing the switch circuit can be reduced. In particular, high AC voltage, which is applied to CCFL blocks, is not applied to the semiconductor switch circuits 522a to 521f to switch the open/short state of the primary windings of the isolation transformers 521a to 521f. Accordingly, since the semiconductor switching device to operate at low voltage can be used, a small-size and low-price backlight unit having low power consumption can be realized.

Meanwhile, although MOSFETs are used in the semiconductor switch circuits 522a to 522f of the switch circuit 502 shown in FIG. 13, semiconductor switching devices such as the TRIAC 105 or the photo-TRIAC 106 may be used as shown in FIGS. 7 and 8. Such a semiconductor switching device is employed, so that a switching operation (scanning control function or local dimming for each block) to switch the turn-on/turn-off operation state of CCFL blocks at a high speed in a block unit suitably for the brightness of an input image can be adapted to an LCD which will be described later. Accordingly, the image quality can be improved.

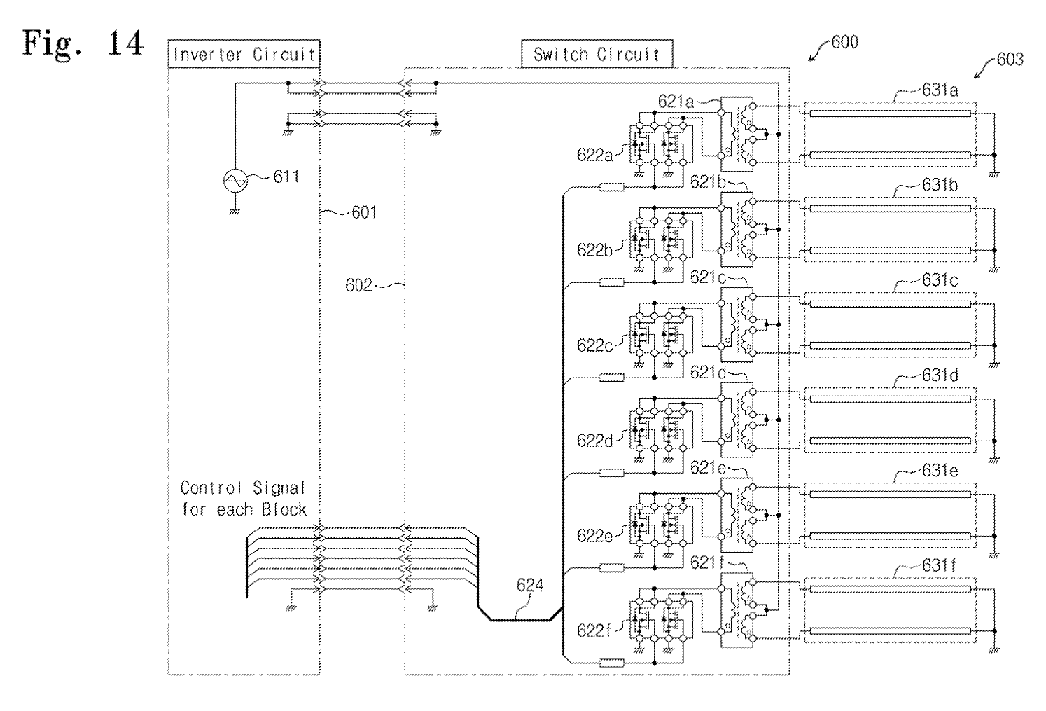

FIG. 14 is a circuit diagram showing a backlight unit 600 according to another embodiment of to the present disclosure. The present embodiment is characterized in that a balance coil is used instead of a condenser circuit including a BC.

Referring to FIG. 14, the backlight unit 600 includes an inverter circuit 601, a switch circuit 602, and a CCFL block group 603.

The inverter circuit 601 includes an AC power source 611 to provide supply voltage to the switch circuit 602. The CCFL block group 603 includes CCFL blocks 631a to 631f. Each of the CCFL blocks 631 to 631f includes two CCFLs.

The switch circuit 602 includes isolation transformers 621a to 621f and semiconductor switch circuits 622a to 622f which correspond to the CCFL blocks 631a to 631f in number.

A secondary winding of each of the isolation transformers 621a to 621f is divided (e.g., center tapped) in each CCFL provided in the CCFL blocks 631a to 631f to thereby construct a balanced coil. The central tap point of the secondary winding of each of the isolation transformers 621a to 621f is connected to an output terminal of the AC power source 611, and the opposed non-center ends of the secondary windings are connected to a respective one or more CCFLs. In addition, both ends of a primary winding of each of the isolation transformers 621a to 621f are connected to each of the semiconductor switch circuits 622a to 622f. Each of the semiconductor circuits 622a to 622f includes two FETs and two diodes, and base terminals of the two FETs are connected to an input line 624 through which a control signal for each block is input. The semiconductor switch circuits 622a to 622f receive a control signal (ON/OFF signal) for each block through the base terminal connected to the input line 624 to perform a switching operation so that the primary winding is shorted or opened.

When the semiconductor switch circuits 622a to 622f are in an off state, the primary windings of the isolation transformers 621a to 621f are opened. When the semiconductor switch circuits 622a to 622f are in an on state, the primary windings of the isolation transformers 621a to 621f are shorted. The on/off operation time of the semiconductor switch circuits 622a to 622f is controlled based on the control signal(ON/OFF signal) for each block, so that the turn-on/turn-off operation time of the CCFL blocks 631a to 631f can be time-division controlled.

Accordingly, the voltage stress of the switch circuit can be improved, and isolation transformers 621a to 621f and the semiconductor switch circuits 622a to 622f having a low voltage stress characteristic can be used, so that a small-size and low-price switch circuit having low power consumption can be realized. Accordingly, the power consumption, size, and price of a backlight unit employing the switch circuit can be also reduced. In particular, since high AC voltage, which is applied to CCFL blocks, is not applied to the semiconductor switch circuits 622a to 622f to switch the open/short state of the primary winding of the isolation transformers 621a to 621f, a semiconductor switching device operating at low voltage can be used, thereby contributing to the reduction of the power consumption, size, and price of the backlight unit. Further, the secondary winding of the isolation transformers 621a to 621f is divided to construct a balanced coil structure, so that a distribution-balancing condenser can be omitted, and the price of the inverter driving circuit can be more reduced. Since the resonance frequency is adjusted by using only an inductance component and without concern for the capacitance of balancing condensers (not present), impedance matching with CCFLs can be more easily adjusted so that the turn-on/turn-off operation can be easily controlled.

Although FETs are used in the switching transformers 622a to 622f of the switching circuit 602 a shown in FIG. 14, a semiconductor switching device such as the TRIAC 105, or the photo-TRIAC 106 can be used as shown in FIGS. 7 to 9. Such a semiconductor switching device is employed, so that a switching operation (scanning control function or local dimming for each block) to switch the turn-on/turn-off operation state of CCFL blocks at a high speed in a block unit suitably for the brightness of an input image can be adapted to an LCD which will be described later. Accordingly, the image quality can be improved.

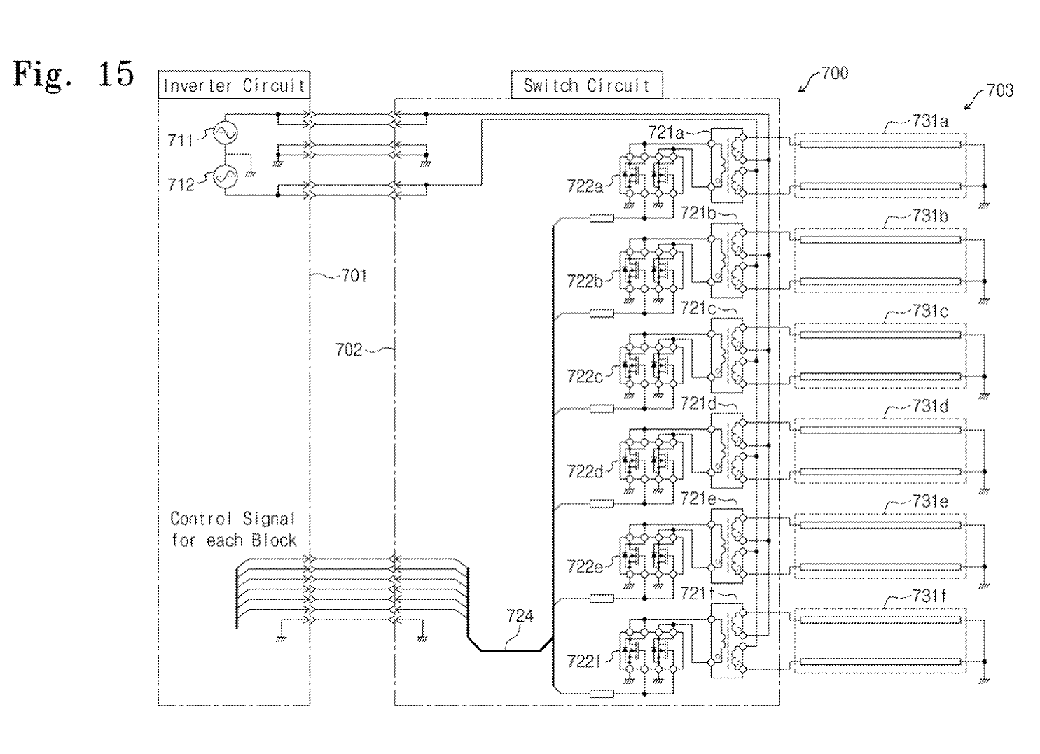

FIG. 15 is a circuit diagram showing a backlight unit 700 according to another embodiment of the present disclosure. The illustrated embodiment is again characterized in that a balance coil structure is used instead of a condenser circuit including a BC. Moreover, independent and optionally differently phased signal sources 711, 712 are used to power each CCFL block (e.g., 731a).

Referring to FIG. 15, the backlight unit 700 includes an inverter circuit 701, a switch circuit 702, and a CCFL block group 703.

The high voltage lamps driving circuit 701 includes a normal-phase AC power source 711 and a differently phased (e.g., inverse-phased) power source 712, and normal-phase supply voltage and inverse-phase supply voltage signals are supplied to the switch circuit 702. The CCFL block group 703 includes CCFL blocks 731a to 731f. Each of the CCFL blocks 731a to 731f includes an even number (e.g., two) of CCFLs.

The switch circuit 702 includes isolation transformers 721a to 721f and semiconductor switch circuits 722a to 722f that correspond to the CCFL blocks 731a to 731f in number.

A secondary windings of the isolation transformers 721a to 721f are each divided in each CCFL block among CCFL blocks 731a to 731f to thereby construct a balanced coil structure. Inner ends of the divided secondary winding of each of the isolation transformers 721a to 721f are connected to output terminals of the normal-phase power source 711 and the inverse-phase power source 712, respectively. Outer ends of the secondary winding of each of the isolation transformers 721a to 721f are connected to the CCFLs. Both ends of a primary winding are connected to each of the semiconductor switch circuits 722a to 722f. Each of the semiconductor switch circuits 722a to 722f includes two FETs and two diodes, and base terminals of two FETs are connected to an input line 724 through which a control signal for each block is input. The semiconductor switch circuits 722a to 722f receive a control signal (ON/OFF signal) for each block through the base terminals connected to the input line 724 to perform a switching operation to short or open the primary windings.

When the semiconductor switch circuits 722a to 722f are in an off state, the primary windings of the isolation transformers 721a to 721f are opened. When the semiconductor switch circuits 722a to 722f are in an on state, the primary windings of the isolation transformers 721a to 721f are shorted. Accordingly, an on/off operation time of the semiconductor switch circuit 722a to 722f is controlled based on the control signal (ON/OFF signal) for each block, so that the turn-on/turn-off operation time of each of the CCFL blocks 731a to 731f can be time-division controlled.

Accordingly, the voltage stress of the switch circuit can be reduced, and isolation transformers 721a to 721f and the semiconductor switch circuits 722a to 722f having a low voltage stress characteristic can be used, so that a small-size and low-price switch circuit having low power consumption can be realized. Accordingly, the power consumption, size, and price of a backlight circuit employing the above switch circuit can be also reduced. In particular, since high AC voltage, which is applied to CCFL blocks, is not applied to the semiconductor switch circuits 722a to 722f to switch the open/short state of the primary windings of the isolation transformers 721a to 721f, a semiconductor switching device operating at low voltage can be used, thereby contributing to the reduction of the power consumption, size, and price of the backlight unit. Further, the secondary winding of the isolation transformers 721a to 721f is divided to construct a balance coil, so that a corresponding balance condenser (BC) can be omitted. Accordingly, the price of the inverter circuit can be more reduced. Since the resonance frequency is adjusted by using only an inductance component, impedance matching with CCFLs can be easily adjusted so that the turn-on/turn-off operation can be easily controlled.

In the inverter circuit 702 shown in FIG. 15, although MOSFETs are used in the semiconductor switch circuits 722a to 722f, a semiconductor switching device such as the TRIAC 105 or the photo-TRIAC 106 can be used as shown in FIGS. 7 to 9. Such a semiconductor switching device is employed, so that a switching operation (scanning control function or local dimming for each block) to switch the turn-on/turn-off operation state of CCFL blocks at a high speed in a block unit suitably for the brightness of an input image can be adapted to an LCD. Accordingly, the image quality can be improved.

The secondary winding of the isolation transformers 621a to 621f is evenly divided to construct a balance coil as shown in FIG. 14, so that a JIN type transformer normally used as a conventional balance coil can be removed. Accordingly, an isolation transformer performing both functions of an inverter transformer and a balance coil is used, thereby more reducing the size and the price of the inverter circuit.

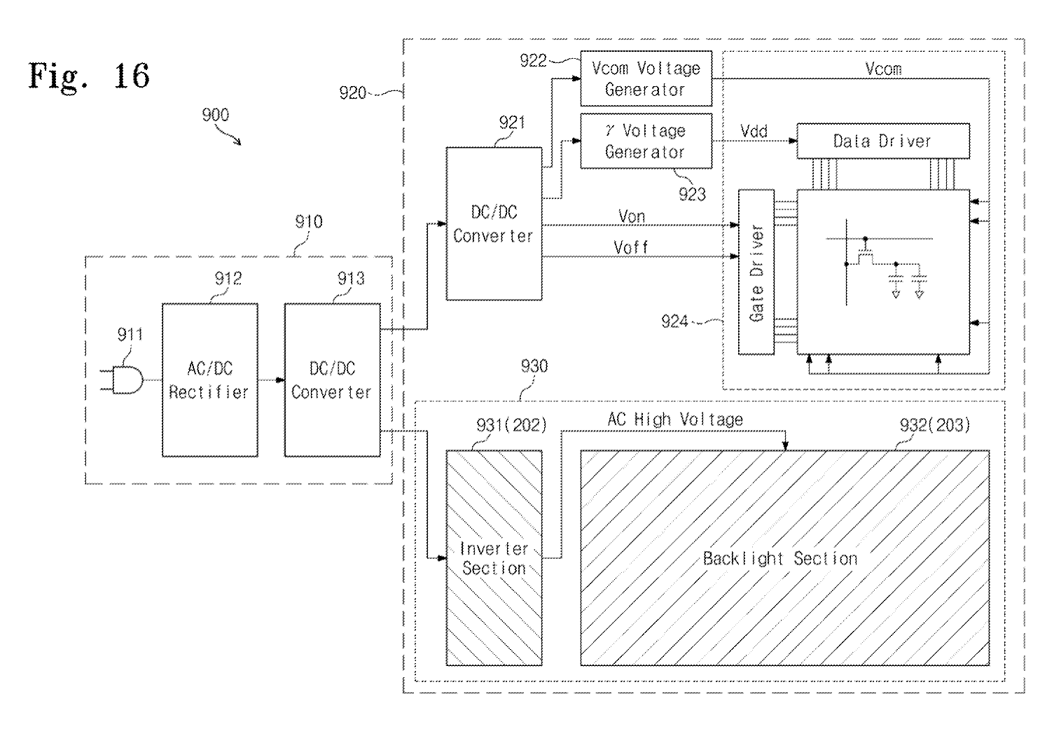

FIG. 16 is a block diagram showing an LCD 900 including a backlight unit 930 having the structure similar to that of the backlight unit 200 shown in FIG. 10.

As shown in FIG. 16, the LCD 900 includes an AC/DC power supply 910, an LCD module 920, and the backlight unit 930

The AC/DC power supply 910 includes an AC power plug 911, an AC/DC rectifier 912, and a first DC-to-DC converter 913. The AC/DC power supply 910 converts external commercial AC supply voltage (100V or 240V) into DC supply voltage and outputs the DC supply voltage to the LCD module 920 by way of the first DC-to-DC converter 913.

The LCD module 920 includes a second DC/DC converter 921, a common electrode (Vcom) voltage generator 922, a gamma (γ) voltage generator 923, an LCD panel 924, and the backlight unit 930 to display images corresponding to image data provided from an external graphic controller (not shown). The LCD panel 924 includes a plurality of liquid crystal devices connected to each other at a region in which a plurality of data lines and a plurality of gate lines extending from data and gate drivers, respectively, cross each other. The liquid crystal devices are distributed in a plurality of display regions to control the gray scale of each display region.

The Vcom generator 922 generates common electrode voltage Vcom based on level-converted DC voltage supplied from the second DC/DC converter 921 and outputs the common electrode voltage Vcom to the LCD panel 924. The γ voltage generator 923 generates γ voltage Vdd based on the level-converted DC voltage in the DC/DC converter 921 to supply the γ voltage to the LCD panel 924. Although, the Vcom generator 922 and the γ voltage generator 923 are separated from the LCD panel 924 as shown in FIG. 16, the Vcom generator 922 and the γ voltage generator 923 may be embedded in the LCD panel 924.

The backlight unit 930 includes an inverter section 931 and a backlight section 932. The inverter section 931 includes the isolation transformers 221a to 221f, the switching transistors 222a to 222f, and the optional condenser circuits 223a to 223f provided in the switch circuit 202 such as shown in FIG. 10. The backlight section 932 includes the CCFL block group 203 shown in FIG. 10. A plurality of CCFL blocks in the CCFL block group 203 correspond to the plural display regions, respectively. The turn-on/turn-off operation time of the CCFL blocks is time-division controlled corresponding to the brightness of each display region when an input image is displayed on the LCD panel 924.

Since the inverter section 931 provided in the backlight unit 930 of the LCD 900 includes the isolation transformers 221a to 221f, the switching transistors 222a to 222f, and the condenser circuits 223a to 223f, the voltage stress of the switch circuit can be reduced, and the isolation transformers 221a to 221f and the switching transistors 222a to 222f having a low voltage stress characteristic can be used. Therefore, a small-size and low-price switch circuit having low power consumption can be realized. As a result, the power consumption and cost of a backlight circuit employing the above switch circuit can be also reduced. In addition, a switching function (scanning control function or local dimming function for each block) to switch the turn-on/turn-off operation state of the CCFL blocks at a high speed can be used to control the brightness of a display image according to the brightness of an input image, so that the image quality of the LCD 900 can be improved. Meanwhile, the AC/DC power supply 910 may be embedded in the LCD module 920.

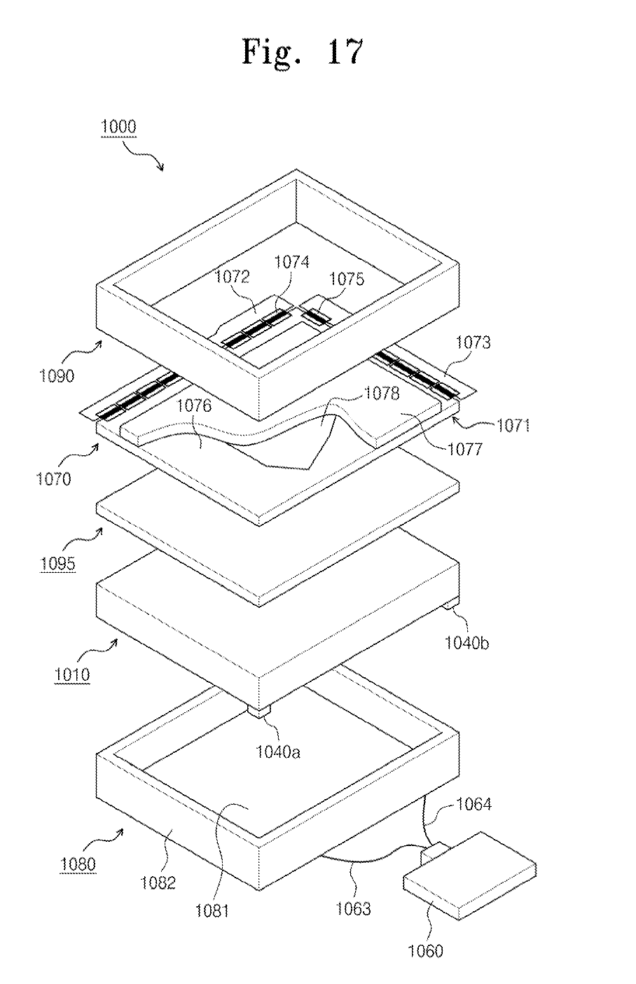

FIG. 17 is an exploded perspective view showing an assembly of LCD 1000 having the structure similar to that of the LCD 900 shown in FIG. 16.

As shown in FIG. 17, the LCD 1000 includes a backlight assembly 1010, a display unit 1070, and a container 1080.

The display unit 1070 includes a liquid crystal display panel 1071 to display an image and a data printed circuit 1072 and a gate printed circuit 1073 to output a driving signal used to drive the liquid crystal display panel 1071. The data and gate printed circuits 1072 and 1073 are electrically connected with the liquid crystal display panel 1071 through a data tape carrier package (TCP) 1074 and a gate TCP 1075.

The liquid crystal display panel 1071 includes a first substrate 1076, a second substrate 1077 opposite to the first substrate 1076, and a liquid crystal 1078 interposed between the first and second substrates 1076 and 1077.

The first substrate 1076 may be a transparent glass substrate in which TFTs (not shown) serving as a switching device are provided in the form of a matrix. Data and gate lines are connected to source and gate terminals of each TFT, and a transparent electrode (not shown) including transparent conductive material is formed at a drain terminal

The second substrate 1077 may be a substrate in which RGB pixels (not shown) are formed through a thin film process. The second substrate 1077 is provided thereon with a common electrode (not shown) including transparent conductive material.

The container 1080 includes a bottom surface 1081 and a sidewall 1082 formed along the edge of the bottom surface 1081 to form a receiving space. The container 1080 fixes the backlight assembly 1010 and the liquid crystal display panel 1071 to prevent the backlight assembly 1010 and the liquid crystal display panel 1071 from moving.

The bottom surface 1081 has an area sufficient to receive the backlight assembly 1010 and has configuration corresponding to that of the backlight assembly 1010. According to the present embodiment, the bottom surface 1081 and the backlight assembly 1010 have a rectangular plate shape. The sidewall 1082 approximately perpendicularly extends from the edge of the bottom surface 1081 such that the backlight assembly 1010 does not deviate out of the container 1080.

According to the present embodiment, the LCD 1000 further includes an inverter circuit 1060 and a top chassis 1090.

The inverter circuit 1060 is disposed outside of the container 1080 to generate high voltage discharge signals used to drive the lamps of the backlight assembly 1010. The discharge voltage generated from the inverter circuit 1060 is applied to the backlight assembly 1010 through first and second power lines 1063 and 1064. The first and second power lines 1063 and 1064 may be connected with first and second electrodes 1040a and 1040b, which are formed at both side portions of the backlight assembly 1010, directly or by using another part (not shown). In addition, the switch circuit 202 including the isolation transformers 221a to 221f, the switching transistors 222a to 222f, and the condenser circuits 223a to 223f may be embedded in the inverter circuit 1060.

The top chassis 1090 is coupled with the container 1080 while surrounding the edge of the liquid crystal display panel 1071. The top chassis 1090 can protect the liquid crystal display panel 1071 from external shock, and prevent the liquid crystal display panel 1071 from deviating from the container 1080.

The LCD 1000 may further include at least one optical sheet 1095 to improve the characteristic of light output from the backlight assembly 1010. The optical sheet 1095 may include a diffusion sheet to diffuse light or a prism sheet to concentrate light.

Accordingly, when the inverter circuit 1060, which performs a scanning control function for the turning-on operation of a CCFLA block group or a control function for the turn-on/turn-off operation time of each CCFL block by shorting or opening the primary windings of the isolation transformers through the ON/OFF operation of switching transistors, is adapted for an LCD including a power supplying inverter, the voltage stress of the inverter circuit 1060 can be reduced, and the low power consumption, small-size, and low price of the inverter circuit 1060 can be realized. In addition, the above-described backlight unit 100, 200, or 300 is adapted to the LCD 1000, so that a switching function (scanning control function or local dimming function for each block) to switch the turn-on/turn-off operation state of the CCFL blocks at a high speed in a block unit can be performed in order to control the brightness of a display image according to the brightness of an input image. Accordingly, image quality can be improved.

According to the embodiments of the present disclosure, although the inverter circuit is separated from the switch circuit, the inverter circuit may alternatively be integrated with the switch circuit.

Although exemplary embodiments of the present disclosure have been described, it is understood that the present teachings should not be limited to these exemplary embodiments but various changes and modifications can be made by one ordinary skilled in the art in view of the foregoing and within the spirit and scope of the present teachings.

What is claimed is:

1. A lamp driving circuit comprising:
an isolation transformer that comprises a secondary winding connected between an output terminal of a power source and input terminals of a plurality of discharge tubes in series to supply a high AC voltage to the discharge tubes; and
a switch circuit that switches a state of a primary winding of the isolation transformer into an open state or a short state according to a control signal.

2. The lamp driving circuit of claim 1, wherein the control signal uses voltage levels substantially lower than level of voltages developed across the secondary winding.

3. The lamp driving circuit of claim 2, wherein the switch circuit comprises a semiconductor switch device.

4. The lamp driving circuit of claim 2, wherein the switch circuit comprises a transistor circuit.

5. The lamp driving circuit of claim 1, further comprising one or more balance condensers connected to the secondary winding,
wherein the combination of the one or more balance condensers and the secondary winding of the isolation transformer defines an LC series circuit having a different resonant frequencies depending on whether the primary winding is caused to be in one or another of controllably altered equivalent circuit states by switching of the switch circuit.

6. The lamp driving circuit of claim 5, wherein the isolation transformer is a leakage transformer in which the primary winding and the secondary winding are loosely coupled, and wherein an equivalent circuit inductance value of the secondary winding is determinative of whether the discharge tubes will be ignited into turned on states or kept turned off

7. The lamp driving circuit of claim 5, wherein the secondary winding of the isolation transformer is structured as a balanced coil, and the balanced coil has opposed terminals each respective connected to an input terminal of a balanced load of discharge tubes.

8. A backlight unit comprising:
a power source;
a plurality of discharge tube blocks each comprising a plurality of discharge tubes;
a plurality of isolation transformers installed in correspondence with the discharge tube blocks, the isolation transformers each respectively, comprising secondary windings connected in series to a AC power source and to input terminals of a corresponding discharge tubes block, and the respective isolation transformer being structured to selectively supplying a high voltage AC signal or not to its respective discharge tubes block;
a plurality of switch circuits connected to primary windings of the isolation transformers, respectively, to switch a state of the primary windings between an open circuit state and a shorted circuit state according to a supplied control signal; and
a control circuit that generates the control signal to control switching operations of the switch circuits.

9. The backlight unit of claim 8, wherein the power source comprises a first phased (normal phase) power source and a differently phased (e.g., inverse phase) power source, and the discharge tube blocks are operatively coupled to one or the other of the first phased and differently phased power sources by way of respective isolation transformers,
wherein among the isolation transformers:
the first phased phase isolation transformers that are connected to the normal-phase discharge tube blocks, and each first phased phase isolation transformer comprises a secondary winding connected to the first phased (normal-phase) power source to thereby selectively supply a normal-phase high voltage AC signal to the normal-phase discharge tube blocks; and
differently phased (e.g., inverse-phase) isolation transformers that are connected to the differently phased (e.g., inverse-phase) discharge tube blocks, and each differently phased phase isolation transformer comprise a secondary winding connected to the differently phased (e.g., inverse-phase) power source to thereby selectively supply the inverse-phase high voltage AC signal to the inverse-phase discharge tube blocks, and
wherein the switch circuits are connected to the primary windings of the normal-phase and inverse-phase isolation transformers to switch a state of the primary windings to an open state or a short state according to a control signal.

10. The backlight unit of claim 8, wherein the power source comprises a normal phase power source and an inverse phase power source, and the discharge tube blocks comprise normal-phase discharge tubes and inverse-phase discharge tubes,
wherein the isolation transformers comprise:
normal-phase isolation transformers that are installed at the normal-phase discharge tubes, comprise secondary windings connected between an output terminal of the normal-phase power source and input terminals of the discharge tube blocks in series, and supply a normal-phase high AC voltage to the discharge tube blocks; and
inverse-phase isolation transformers that are installed at the inverse-phase discharge tubes, comprise secondary windings connected between an output terminal of the inverse-phase power source and input terminals of the discharge tube blocks in series, and supply an inverse-phase high AC voltage to the discharge tube blocks, and
wherein the switch circuits comprise:
normal-phase switch circuits connected to primary windings of the normal-phase isolation transformers to switch a state of the primary windings to an open state or a short state according to a control signal; and
inverse-phase switch circuits connected to primary windings of the inverse-phase isolation transformers to switch a state of the primary windings to an open state or a short state according to a control signal.

11. The backlight unit of claim 8, wherein the control signal has a voltage level lower than a level of voltage applied to the secondary windings

12. The backlight unit of claim 11, wherein the switch circuits comprise a semiconductor switch device.

13. The backlight unit of claim 11, wherein the switch circuits comprise a transistor circuit.

14. The backlight unit of claim 8, further comprising a balance condenser connected to each input terminal of the discharge tubes,
wherein each isolation transformer forms an LC series circuit by each secondary winding and the balance condenser and wherein the equivalent circuit values of the primary LC series circuit depends on whether its corresponding primary winding is shorted or not.

15. The backlight unit of claim 14, wherein each isolation transformer is a leakage transformer in which a primary winding and a secondary winding are loosely coupled, and an inductance value of the leakage transformer and a leakage inductance value are determined by a condition of turning on each discharge tube.

16. The backlight unit of claim 14, wherein the secondary winding of each isolation transformer comprises a balance coil, and the balance coil is connected to each input terminal of the discharge tubes

17. A liquid crystal display comprising:
a liquid crystal display panel having a plurality of liquid crystal pixel units, where the pixel units are subdivided into blocks each covering a respective display region on the panel and the blocks of pixel units are structured to collectively display an image in accordance with input image signals that indicate relative luminances to be output from the pixel units; and
a backlight section provided at a rear of the liquid crystal display panel and operative to provide backlighting to the liquid crystal display panel so that the pixel units can output the relative luminances indicated by corresponding input image signals,
wherein the backlight section comprises:
one or more high voltage AC power sources;
a plurality of discharge tube blocks that each comprises a plurality of discharge tubes, where each discharge tube block is disposed for providing backlighting to a corresponding one of the display regions and where each discharge tube can emit light in response to an AC excitation signal having a voltage equal to or greater than a predetermined minimum excitation voltage level;
a plurality of isolation transformers operatively coupled to respective ones of the discharge tube blocks, where each isolation transformer includes a secondary winding interposed in series between a corresponding one of the high voltage AC power sources and at least one of the discharge tube blocks, where the secondary winding has a respective primary side impedance whose value can determine at least one of magnitude and phase of high voltage AC excitation developed across the corresponding at least one discharge tube block, each isolation transformer also having at least one primary winding that is DC wise electrically isolated from but magnetically coupled to the secondary winding of that isolation transformer;
a plurality of switch circuits each connected to a respective one of the primary windings of the isolation transformers, each switch circuit being operatively responsive to a supplied control signal to switch a state of its corresponding the primary windings between a first impedance state and a different second impedance state where the first impedance state can be an open circuit state of the corresponding primary winding and the second impedance state can be a short circuited state of the corresponding primary winding according to the supplied control signal; and
a control circuit operatively coupled to supply respective control signals to respective ones of the plurality of switch circuits to thereby control respective switching operations of the switch circuits.

18. The liquid crystal display of claim 17, wherein the one or more high voltage AC power sources include a first phased (normal-phased) power source and a differently phased (e.g., inverse-phased) power source, and the discharge tube blocks are operatively coupled to so as to be respectively driven by at least one or the other of the first and second phased power sources,
wherein a first subset of the isolation transformers each has its respective secondary winding interposed in series between a corresponding first phased one of the power sources and its corresponding discharge tube block and a second subset of the isolation transformers each has its respective secondary winding interposed in series between a corresponding second phased one of the power sources and its corresponding discharge tube block.

19. The liquid crystal display of claim 17, wherein the one or more high voltage AC power sources comprise a normal phase power source and an inverse phase power source, and the discharge tube blocks comprise normal-phase discharge tubes and inverse-phase discharge tubes,
wherein the isolation transformers comprise:
normal-phase isolation transformers that are installed at the normal-phase discharge tubes, comprise secondary windings connected between an output terminal of the normal-phase power source and input terminals of the discharge tube blocks in series, and supply a normal-phase high AC voltage to the discharge tube blocks; and
inverse-phase isolation transformers that are installed at the discharge tubes, comprise secondary windings connected between an output terminal of the inverse-phase power source and input terminals of the discharge tube blocks in series, and supply an inverse-phase high AC voltage to the discharge tube blocks, and
wherein the switch circuits comprise:
normal-phase switch circuits connected to primary windings of the normal-phase isolation transformers to switch a state of the primary windings to an open state or a short state according to a control signal; and
inverse-phase switch circuits connected to primary windings of the inverse-phase isolation transformers to switch a state of the primary windings to an open state or a short state according to a control signal.

20. The liquid crystal display of claim 17, wherein the control signal is of a substantially lower voltage level than high voltage levels developed across the secondary windings.

21. A method of selectively controlling magnitudes of AC high voltages developed across high voltage lamps of a locally dimmed backlighting unit of a Liquid Crystal Display (LCD) system, the method comprising:
(a) providing a plurality of isolation transformers each having one or more low voltage side primary windings and a high voltage side secondary winding, where the secondary winding of each isolation transformer is interposed in series between a high voltage AC power source and at least one of the high voltage lamps and where the one or more primary windings of each isolation transformer is DC wise electrically isolated from, but magnetically coupled to the secondary winding of that isolation transformer; and
(b) providing a plurality of low voltage controllable switch circuits each operatively coupled to a respective primary winding and each operable in response to a supplied low voltage control signal to switch an impedance state of the respective primary winding at least between first and second different impedance states, where the switch controlled impedance state of the respective primary winding is reflected by mutual coupling into defining a corresponding impedance state of the corresponding secondary winding so that switchings of the low voltage controllable switch circuits operate to alter equivalent circuit impedances of corresponding high voltage side secondary windings and thereby alter magnitudes of high voltage excitation signals developed across the corresponding high voltage lamps.
